(19) United States
(12) Patent Application Publication
(10) Pub. No.: US 2009/0295896 A1
(43) Pub. Date: Dec. 3, 2009

(54) RECORDING APPARATUS

(75) Inventors: Shintaro KOMURO, Shiojiri-shi (JP); Nobuhiko SHINOZAKI, Shiojiri-shi (JP); Tomoya TAKIKAWA, Shiojiri-shi (JP); Sanshiro TAKESHITA, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/471,901

(22) Filed: May 26, 2009

(30) Foreign Application Priority Data
May 27, 2008 (JP) 2008-138756

(51) Int. Cl. B41J 2/01

(52) U.S. Cl. 347/104

(57) ABSTRACT

A recording apparatus includes a recording executing section, a transport driving roller, and an ejection driving roller. The recording executing section can execute recording on both a first recording material and a second recording material set on a first surface of a holding tray in a recording execution area. The transport of the holding tray in the recording execution area is performed by the feeding force of the transport driving roller and the ejection driving roller, and the maintenance of the posture of the holding tray in the recording execution area is performed by the transport driving roller, the ejection driving roller, and a posture maintainer located outside a transit area through which the first recording material passes.

### BACKGROUND

1. Technical Field

The present invention relates to a recording apparatus that can execute recording on both a first recording material that is soft, for example, plain paper, and a second recording material that is hard, for example, a CD-R, set on a holding tray. Examples of such a recording apparatus include a printer, a facsimile, a copier, and a multifunction device.

2. Related Art

A description will be given of an ink jet printer, which is an example of a recording apparatus. Some ink jet printers can selectively execute recording on both a soft recording material, for example, paper or a film, and a hard recording material, for example, an optical disk (such as a CD-R or DVD-R). When recording is executed on a hard recording material such as a CD-R, a special holding tray provided as an attachment is used, or, as shown in JP-A-2005-59584, an ink jet printer in which a holding tray is built in a printer body is used. The holding tray is provided with a depressed portion in which a recording material such as a CD-R is set.

The transport of the two types of recording materials to the recording execution area and the ejection thereof out of the recording apparatus body are executed using the same transport roller and ejection roller. The transport roller includes a transport driving roller and a transport driven roller. The ejection roller includes an ejection driving roller and an ejection driven roller. For executing recording on a hard recording material using a special holding tray, the transport roller and ejection roller are set to the same height so that the recording material in the recording execution area is parallel to the ink ejection surface of the recording head.

On the other hand, when transporting a soft recording material, it is preferable to press the recording material against the platen and thereby stabilize the gap between the recording material and the ink ejection surface of the recording head from the viewpoint of preventing the recording material from rubbing against the head and improving the quality of recording execution. In this case, it is effective to set the ejection driving roller higher than the transport driving roller.

However, if the ejection driving roller is set higher than the transport driving roller, when a hard recording material is transported using a holding tray, the holding tray and the recording material incline, and the parallelism with respect to the ink ejection surface of the recording head deteriorates. Therefore, when recording is executed on a hard recording material, the gap between the ink ejection surface of the recording head and the recording surface of the recording material is unstable, and the quality of recording execution is reduced.

The ejection driving roller is normally a rubber roller. Therefore, the ejection driving roller deteriorates with time due to prolonged use, and the diameter thereof decreases due to wear. If the diameter of the ejection driving roller decreases, the parallelism of the holding tray cannot be maintained, the gap between the lower surface (ink ejection surface) of the recording head and the recording surface of the recording material vary, and the quality of recording execution is reduced.

### SUMMARY

An advantage of some aspects of the invention is to reduce the problem of deterioration in parallelism of the holding tray relative to the recording head due to temporal deterioration of the ejection driving roller due to prolonged use.

According to an aspect of the invention, a recording apparatus includes a recording executing section, a transport driving roller, and an ejection driving roller. The recording executing section can execute recording on both a first recording material and a second recording material set on a first surface of a holding tray in a recording execution area. The transport driving roller applies feeding force toward the recording execution area to a second surface of the holding tray. The ejection driving roller is located downstream of the transport driving roller and applies feeding force that feeds the first recording material from the same side as the transport driving roller in the ejecting direction, to the first recording material. The transport of the holding tray in the recording execution area is performed by the feeding force of the transport driving roller and the ejection driving roller, and the maintenance of the posture of the holding tray in the recording execution area is performed by the transport driving roller, the ejection driving roller, and a posture maintainer located outside a transit area through which the first recording material passes.

According to this aspect, the maintenance of the posture of the holding tray in the recording execution area is performed by the transport driving roller, the ejection driving roller, and a posture maintainer located outside a transit area through which the first recording material passes. Therefore, by adding the posture maintainer, the rate at which the diameter of the ejection driving roller decreases due to wear can be maintained at a low level. Therefore, the temporal deterioration of the ejection driving roller due to prolonged use can be suppressed to a low level, and the problem of decrease in parallelism of the holding tray relative to the recording head can be reduced. In addition, the wear of the ejection driving roller is also reduced.

The posture maintainer does not come into contact with the first recording material being transported and comes into contact with the holding tray only when recording is executed on the second recording material. Therefore, the deterioration due to wear of the posture maintainer is extremely small. Therefore, the problem of decrease in parallelism of the holding tray relative to the recording head can be reduced.

Even when the diameter of the ejection driving roller has decreased due to wear, the parallelism of the holding tray in the recording execution area can be maintained at a permissible level thanks to the posture maintainer.

It is preferable that the curved surface of the transport driving roller and the curved surface of the ejection driving roller be initially in contact with the second surface of the holding tray, the posture of the holding tray be maintained in the contact state, the top of the posture maintainer be initially set at a position distant from the second surface of the holding tray, the variation with time of the posture of the holding tray bring the top of the posture maintainer into contact with the second surface of the holding tray, and the posture of the holding tray be thereby maintained.

In this case, when the diameter of the ejection driving roller has decreased due to wear by a predetermined amount, the posture maintainer acts together with the transport driving roller so as to maintain the parallelism of the holding tray. Therefore, the deterioration in parallelism of the holding tray is maintained at a permissible extremely low level and has little effect on the quality of recording execution.

It is preferable that the posture maintainer be provided downstream of the transport driving roller.

Since the posture maintainer is provided downstream of the transport driving roller, when the second recording material is transported, the parallelism of the holding tray is maintained by the curved surface of the transport driving roller and the posture maintainer just after the holding tray passes through the nip of the transport driving roller. Therefore, if the length of the holding tray is reduced, the holding tray can be stably transported with the parallelism maintained.

It is preferable that the posture maintainer be provided on a part of the roller driving shaft of the ejection driving roller near the ejection driving roller.

In this case, the holding tray can be supported not only near the left and right edges of the transit area through which the first recording material passes but also at a plurality of places near the ejection driving roller. Therefore, the parallelism of the holding tray becomes more stable. In addition, since the posture maintainer is provided near the ejection driving roller, it is possible to sensitively detect the decrease in diameter of the ejection driving roller and to minimize the deterioration in parallelism of the holding tray.

According to another aspect of the invention, a recording apparatus includes a transport driving roller, a recording executing section, an ejection driving roller, and a posture maintainer. The transport driving roller supports both a first recording material and a second recording material set on a holding tray while applying transporting force thereto. The recording executing section faces the first and second recording materials being transported. The ejection driving roller is located downstream of the transport driving roller and supports the first recording material and the holding tray while applying transporting force thereto. The posture maintainer supports the holding tray together with the transport driving roller and thereby defines the supported posture of the holding tray relative to the recording executing section. The posture maintainer is located downstream of the transport driving roller and supports the holding tray substantially without applying driving force thereto. The posture maintainer is provided outside a transit area corresponding to the standardized size of the first recording material.

### BRIEF DESCRIPTION OF THE DRAWINGS

The invention will be described with reference to the accompanying drawings, wherein like numbers reference like elements.

FIG. 1 is a perspective view showing the internal structure of an ink jet printer with a holding tray located at a set position.

FIG. 2 is a side sectional view showing the outline of the internal structure of the ink jet printer with the holding tray located at a scanning area.

FIG. 3 is a perspective view showing a recording material transport device with a holding tray located at a set position.

FIG. 4 is a side sectional view showing the recording material transport device with the holding tray located at a recording execution area.

FIG. 5 is a plan view of the recording material transport device with the holding tray located at the recording execution area.

FIG. 6 is a sectional view taken along line VI-VI of FIG. 5, part thereof enlarged.

FIG. 7 is a sectional view taken along line VII-VII of FIG. 5, part thereof enlarged.

FIG. 8 is a perspective view showing the upper surface of the holding tray.

FIG. 9 is a perspective view showing the lower surface of the holding tray.

FIG. 10 is a plan view showing another embodiment.

FIG. 11A is a sectional view taken along line XIA-XIA of FIG. 10.

FIG. 11B is a sectional view taken along line XIB-XIB of FIG. 10.

FIG. 12 is a vertical sectional view showing still another embodiment taken along the nip of the ejection roller.

### DESCRIPTION OF EXEMPLARY EMBODIMENTS

Hereinafter, a recording apparatus having a recording material transport device according to the invention will be described. First, an ink jet printer 1 will be taken as an exemplary embodiment of a printer of the invention, and the overall configuration thereof will be outlined with reference to the drawings.

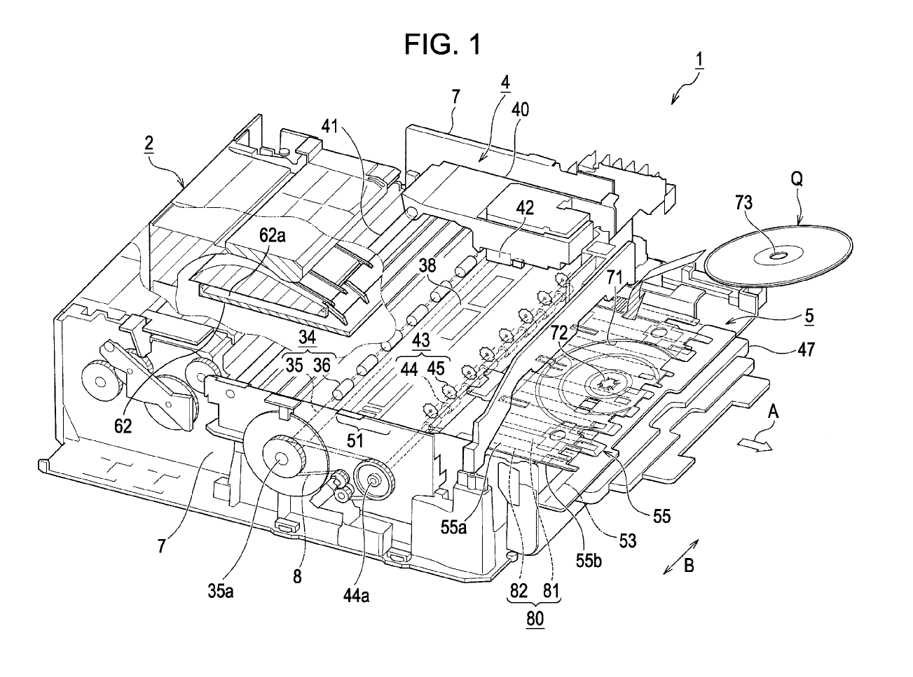

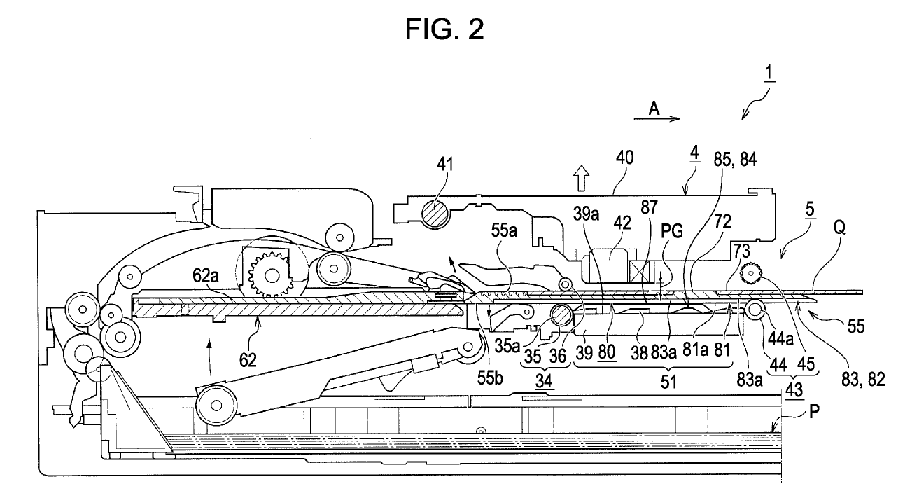

FIG. 1 is a perspective view showing the internal structure of the ink jet printer with a holding tray located at a set position. FIG. 2 is a side sectional view showing the outline of the internal structure of the ink jet printer with the holding tray located at a recording execution area. The shown ink jet printer 1 is a multifunctional ink jet printer on which an image scanner (not shown) is mounted, and it can execute recording on both a first recording material P that is soft, for example, paper or a film, and a second recording material Q that is hard, for example, an optical disk such as a CD-R or DVD-R.

This ink jet printer 1 has a printer body 2 that is a rectangular case-like recording apparatus body having an appearance composed of relatively flat surfaces. The printer body 2 has a recording material transport device 5 and a recording execution device 4 therein. The recording material transport device 5 transports the first recording material P or the second recording material Q to a recording execution area 51, and after the execution of recording, it ejects the first recording material P or the second recording material Q out of the printer body 2. The recording execution device 4 executes a desired recording and forms an image on the first recording material P or the second recording material Q transported to the recording execution area 51.

The recording material transport device 5 has a holding tray 55. The holding tray 55 has a depressed portion 71 and a chuck 72 formed on the upper surface thereof and a depression projection structure 80 formed on the lower surface 55b thereof. In the depressed portion 71, the second recording material Q is set. The chuck 72 holds the edge 73 of the center hole of the second recording material Q. The depression projection structure 80 will be described below. In addition, the recording material transport device 5 has a transport roller 34 and an ejection roller 43. The transport roller 34 includes a transport driving roller 35 and transport driven rollers 36 and transports one of the two types of recording materials, the first recording material P or the second recording material Q, to the recording execution area 51. The ejection roller 43 includes ejection driving rollers 44 and ejection driven rollers 45, and after the execution of recording, it ejects the first recording material P or the second recording material Q out of the printer body 2 (forward from the printer body 2 in this embodiment). The ejection driven rollers 45 are retracted by a release mechanism (not shown) to a position where the ejection driven rollers 45 are out of contact with the second recording material Q.

The holding tray 55 is a short-depth rectangular flat plate-like member in this embodiment. In the upper surface 55a of the holding tray 55, the depressed portion 71 is formed. The depressed portion 71 is located in the middle of the upper surface 55a in the width direction B and slightly offset forward from the middle of the upper surface 55a in the depth direction. In the center of the depressed portion 71, the chuck 72 is formed. Various optical disks with a diameter of 12 cm or 8 cm, such as a CD-R, CD-RW, DVD-R, DVD-RW, and Blu-ray Disc, can be set as a second recording material Q on the holding tray 55.

The transport roller 34 includes a transport driving roller 35 and transport driven rollers 36. The transport driving roller 35 is a long roller that extends in the width direction B. The transport driven rollers 36 are short rollers that are pressed against the curved surface of the transport driving roller 35 and arranged in the width direction B spaced apart from one another. The transport driving roller 35 is a high-rigidity roller formed by coating the middle portion of a roller driving shaft 35a horizontally suspended between side frames 7 of the printer body 2, with a high friction layer having wear-resistant particles and a covering layer.

The ejection roller 43 includes ejection driving rollers 44 and ejection driven rollers 45. The ejection driving rollers 44 are short rubber rollers arranged in the width direction B spaced apart from one another. The ejection driven rollers 45 are disk-like toothed rollers paired with the ejection driving rollers 44. The ejection driving rollers 44 is provided on a roller driving shaft 44a horizontally suspended between the side frames 7 of the printer body 2. The rotation of the roller driving shaft 35a of the transport driving roller 35 is transmitted through a timing belt 8 to the roller driving shaft 44a, and the ejection driving rollers 44 can rotate in synchronization therewith. The first recording materials P ejected by the ejection roller 43 are stacked on an ejection stacker 47 that projects forward.

The recording execution device 4 basically includes a carriage 40 provided in the upper part of the recording execution area 51, a recording head 42 mounted on the lower surface of the carriage 40, and a platen 38 provided in the lower part of the recording execution area 51.

The carriage 40 can reciprocate along a carriage guide shaft 41 that is suspended along the width direction B perpendicular to the direction A in which the second recording material Q is transported. The recording head 42 ejects ink supplied from an ink supply unit (not shown), from nozzle orifices (not shown) formed in the lower surface (ink ejection surface) of the recording head 42, thereby executing recording directly on the upper surface (recording surface) of the first recording material P or the second recording material Q. The platen 38 guides the transport of the recording materials P and Q. The platen 38 supports the lower surface of the first recording material P transported to the recording execution area 51 or the lower surface 55b of the holding tray 55 on which the second recording material Q is set. The platen 38 defines the gap PG between the lower surface (ink ejection surface) of the recording head 42 and the upper surface (recording surface) of the first recording material P or the second recording material Q.

### Embodiment 1

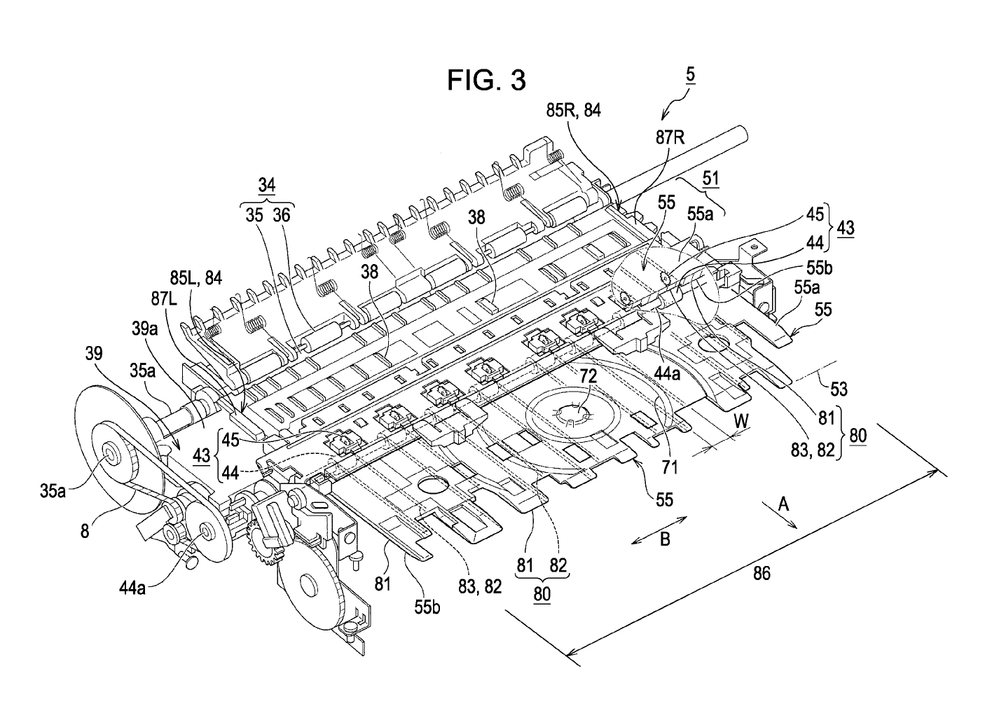

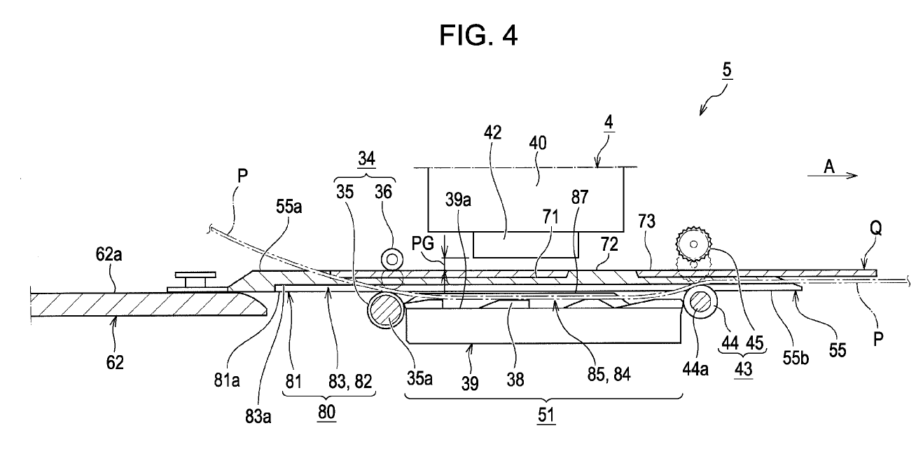

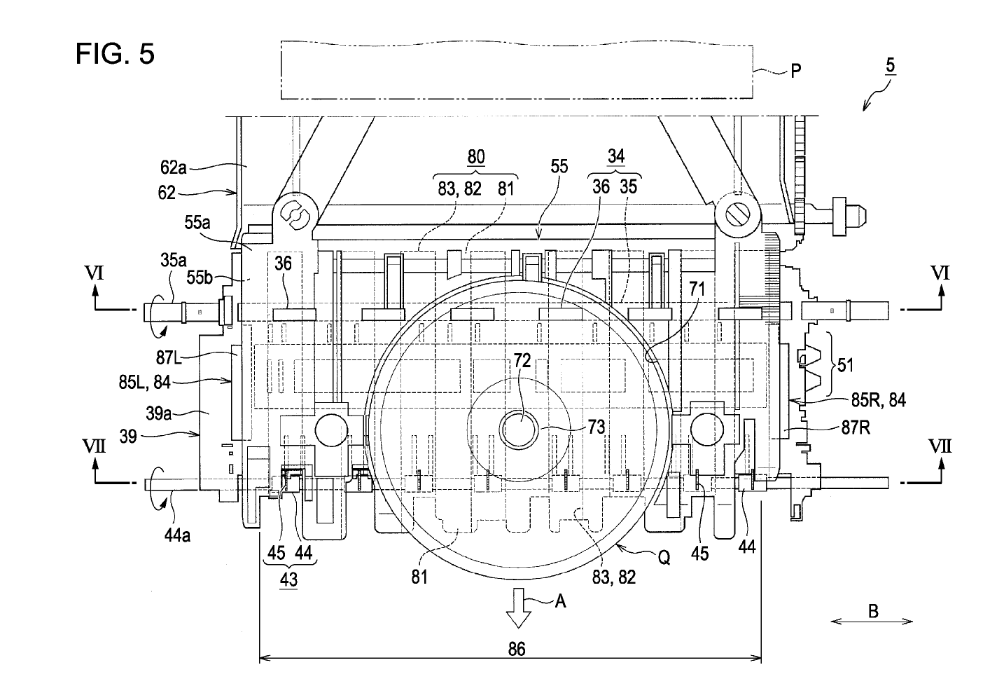

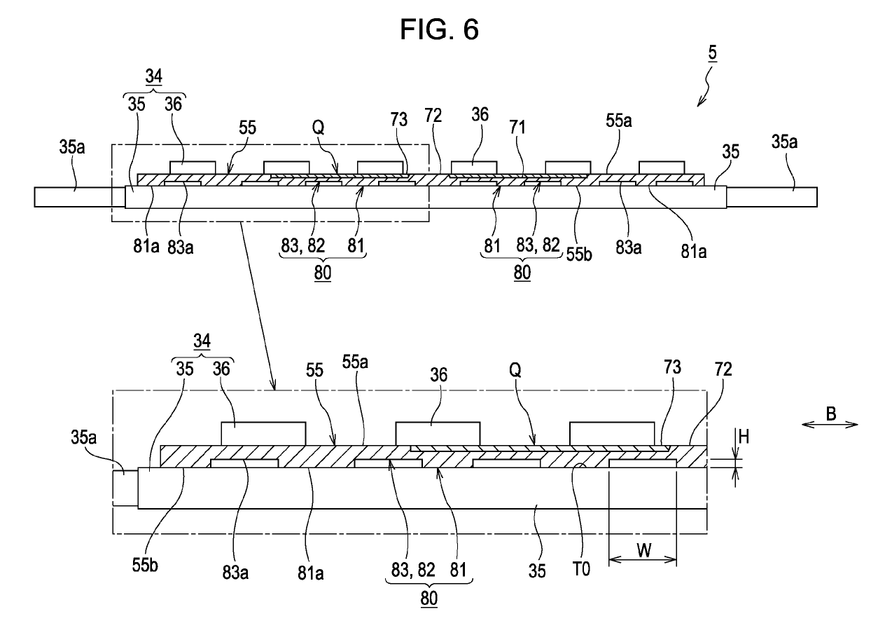

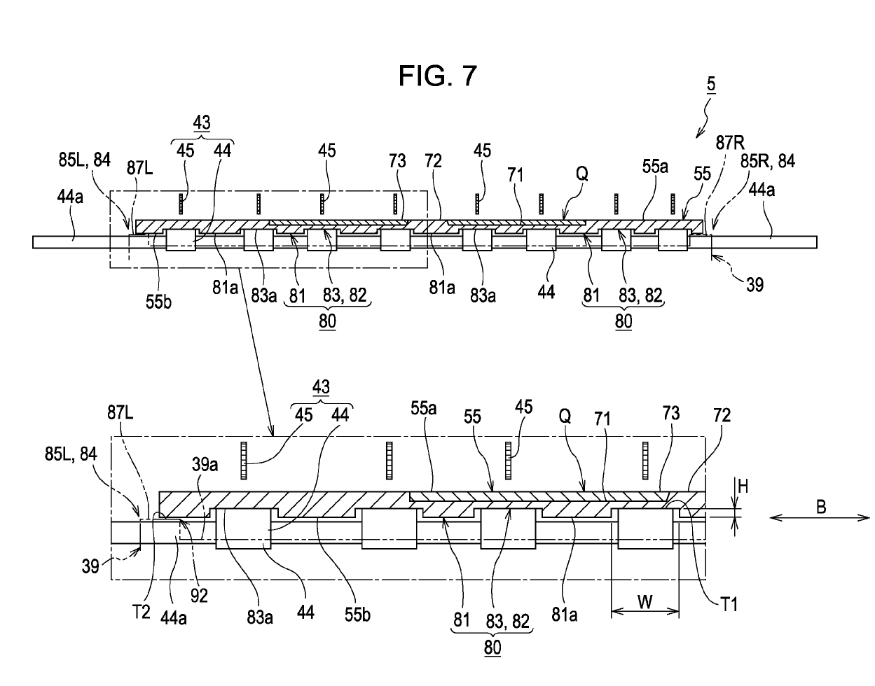

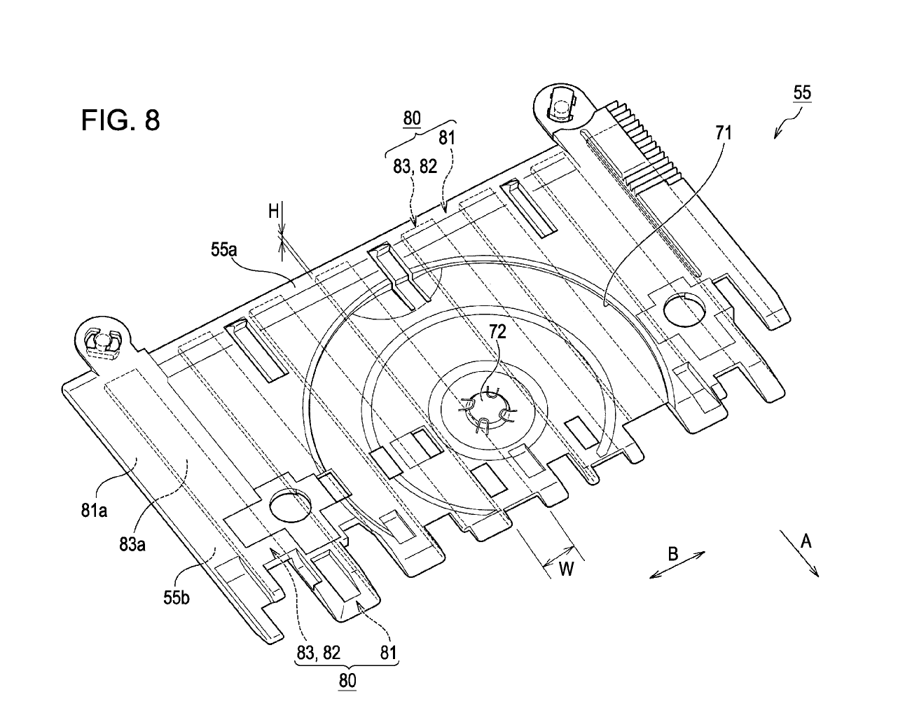

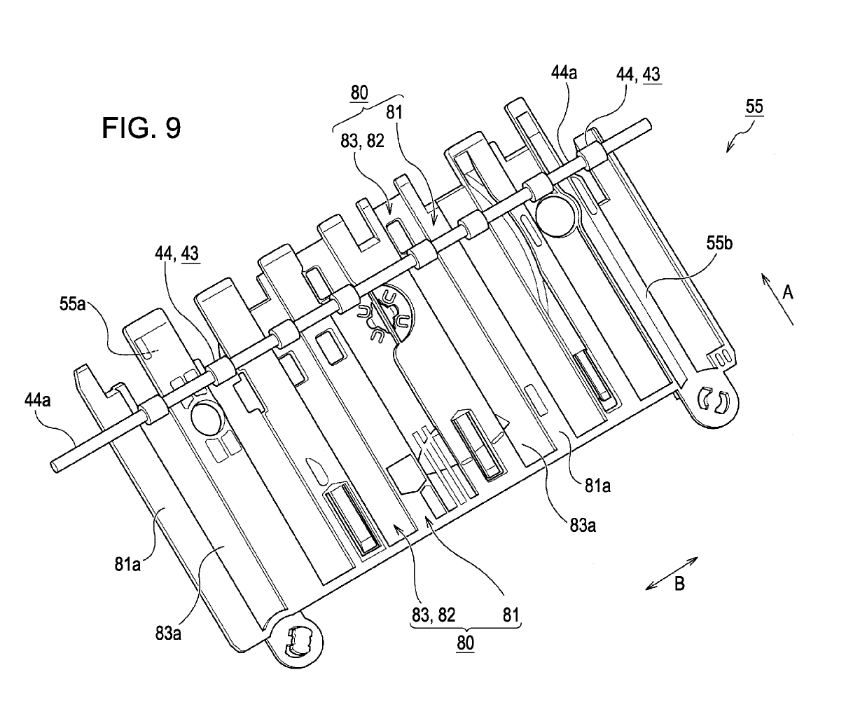

Next, the structure and working of the recording material transport device 5 in the ink jet printer 1 according to this embodiment will be specifically described with reference to the drawings. FIG. 3 is a perspective view showing the recording material transport device of this embodiment with the holding tray located at the set position. FIG. 4 is a side sectional view showing the recording material transport device with the holding tray located at the recording execution area. FIG. 5 is a plan view of the recording material transport device with the holding tray located at the recording execution area. FIG. 6 is a sectional view taken along line VI-VI of FIG. 5, part thereof enlarged. FIG. 7 is a sectional view taken along line VII-VII of FIG. 5, part thereof enlarged. FIG. 8 is a perspective view showing the upper surface (one surface) of the holding tray. FIG. 9 is a perspective view showing the lower surface (the other surface) of the holding tray.

The recording material transport device 5 of this embodiment has the holding tray 55, the transport roller 34, and the ejection roller 43. This embodiment is characterized in that the transport of the holding tray 55 in the recording execution area 51 is performed by the feeding force of the transport roller 34 and the ejection roller 43, and the maintenance of the parallelism (horizontality) of the holding tray 55 in the recording execution area 51 is executed using the transport driving roller 35, the ejection driving rollers 44, and a posture maintainer 84.

In this embodiment, the posture maintainer 84 includes supporting ridges 85L and 85R formed on the upper surface 39a of a transport guide 39 provided downstream of the transport roller 34. The supporting ridges 85L and 85R are provided near the left and right edges, respectively, of a transit area 86 through which the first recording material P passes. The curved surface of the transport driving roller 35 and the curved surfaces of the ejection driving rollers 44 are initially in contact with the lower surface 55b of the holding tray 55, thereby maintaining the horizontality of the holding tray 55.

The upper surfaces 87L and 87R (the tops T2) of the supporting ridges 85L and 85R, respectively, are lower than the lower surface 55b of the holding tray 55. When the parallelism of the holding tray 55 has deteriorated with time, the upper surfaces 87L and 87R of the supporting ridges 85L and 85R, respectively, come into contact with the lower surface 55b of the holding tray 55. Thus, the deterioration in the parallelism of the holding tray 55 can be maintained in a range so as not to affect the quality of recording execution. Therefore, the tops T2 of the supporting ridges 85L and 85R are lower than the top T0 of the curved surface of the transport driving roller 35.

The lower surface 55b of the holding tray 55 is provided with a depression projection structure 80 that includes projections 81 and depressions 82. The projections 81 come into contact with the curved surface of the transport driving roller 35. The depressions 82 receives the ejection driving rollers 44. The number of the depressions 82 is the same as the number of the ejection driving rollers 44. The depressions 82 are grooves 83 that extend parallel to one another along the direction A in which the second recording material Q is transported.

The width W of the grooves 83 is set to a width slightly larger than the length of the ejection driving rollers 44 so that the grooves 83 can receive the ejection driving rollers 44. The depth of the grooves 83 is set to such a depth that when the second recording material Q is transported in a horizontal posture using the holding tray 55, the bottom surfaces 83a of the grooves 83 can come into contact with the curved surfaces of the ejection driving rollers 44.

Next, the working of the above-described recording material transport device 5 of this embodiment will be described in two cases: (1) the case where a first recording material is used and (2) the case where a second recording material is used.

### (1) The Case Where a First Recording Material (for Example, Plain Paper) is Used

In the case where recording is executed using a first recording material P, transporting force is applied to the first recording material P by the transport roller 34 including a pair of nip rollers. As shown by long dashed short dashed line in FIG. 4, the first recording material P enters the recording execution area 51 in a downward-inclined posture so as to be pressed against the upper surface of the platen 38. After that, the first recording material P horizontally slides on the platen 38, and it is transported under the recording head 42 and led to the nip of the ejection roller 43.

The height of the tops T1 of the curved surfaces of the ejection driving rollers 44 is set to a height higher than the top T0 of the curved surface of the transport driving roller 35 by the depth of the depressions 82. Therefore, the first recording material P is subjected to force that presses the first recording material P against the upper surface of the platen 38 also from the ejection roller 43, and the gap PG between the lower surface (ink ejection surface) of the recording head 42 and the upper surface of the first recording material P is stabilized throughout the recording execution area 51. The above-described supporting ridges 85L and 85R provided on the upper surface 39a of the transport guide 39 are provided outside the transit area 86 through which the first recording material P passes. Therefore, the supporting ridges 85L and 85R do not interfere with the transport of the first recording material P.

### (2) The Case Where a Second Recording Material (for Example, a CD-R) is Used

In the case where recording is executed using a second recording material Q, as shown by solid line in FIG. 4, the second recording material Q, held by the holding tray 55, reaches the nip of the transport roller 34. Then, as shown in FIG. 6, the upper surface 55a of the holding tray 55 comes into contact with the curved surfaces of the transport driven rollers 36, and the top surfaces 81a of the projections 81 on the lower surface 55b of the holding tray 55 come into contact with the curved surface of the transport driving roller 35. Thus, transporting force is applied to the holding tray 55, and the holding tray 55 is led to the recording execution area 51.

The holding tray 55, after passing through the nip of the transport roller 34, passes over the upper surfaces 87L and 87R of the supporting ridges 85L and 85R, respectively, and is led to the ejection roller 43. When the front edge of the holding tray 55 reaches the tops of the ejection driving rollers 44 of the ejection roller 43, the ejection driving rollers 44 enter the grooves 83, and the bottom surfaces 83a of the grooves 83 come into contact with the curved surfaces of the ejection driving rollers 44.

In the case where the ejection driving rollers 44 are worn away due to prolonged or frequent use and the diameter thereof has decreased, the top surfaces 81a of the projections 81 on the lower surface 55b of the holding tray 55 come into contact with the upper surfaces 87L and 87R of the supporting ridges 85L and 85R, respectively. Thus, the deterioration in the parallelism of the holding tray 55 due to the wear of the ejection driving rollers 44 can be maintained in a range as described above. In addition, the wear of the ejection driving roller 44 is also reduced.

### Embodiment 2

Although the recording apparatus 1 according to the invention is based on the above-described configuration, of course, modifications, omissions, and so forth may be made without departing from the scope of the invention.

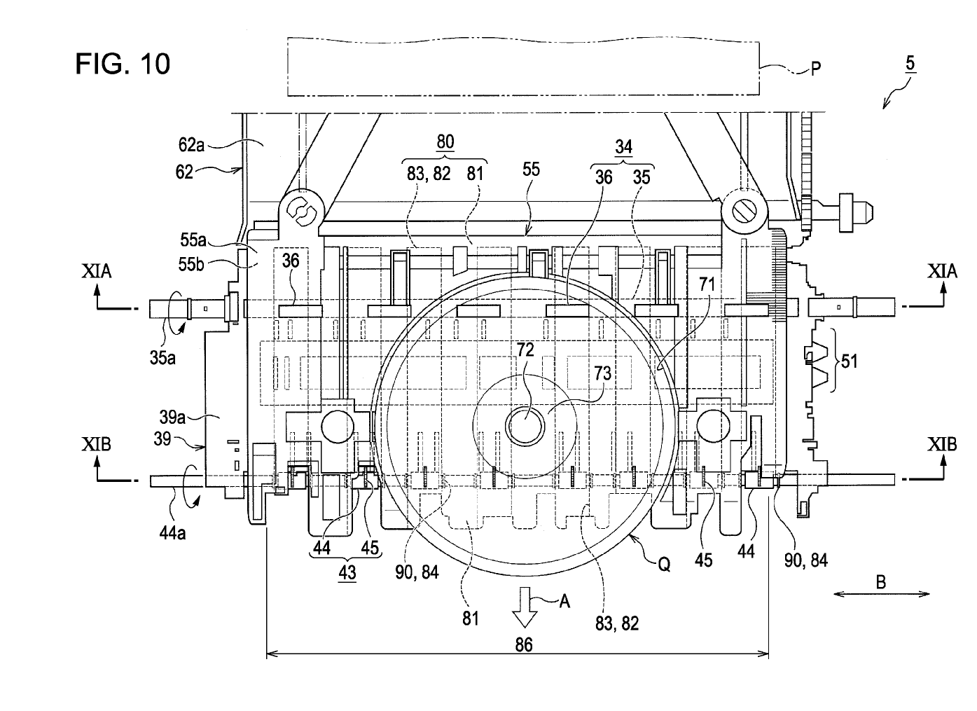

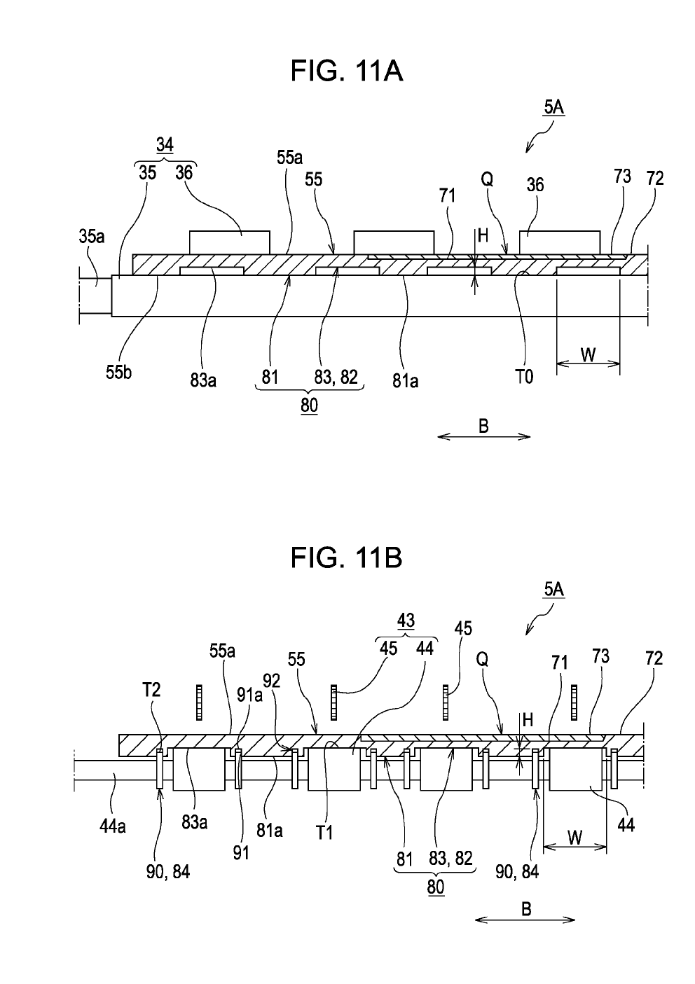

FIG. 10 is a plan view showing another embodiment in which the posture maintainer has a different configuration. FIG. 11A is a sectional view taken along line XIA-XIA of FIG. 10. FIG. 11B is a sectional view taken along line XIB-XIB of FIG. 10.

As shown in FIGS. 10, 11A, and 11B, the posture maintainer 84 can include supporting disks 90 provided on parts of the roller driving shaft 44a near the ejection driving rollers 44. In the embodiment shown in FIGS. 10, 11A, and 11B, slits 91 for receiving the supporting disks 90 are provided near the edges of the grooves 83 in the lower surface 55b of the holding tray 55. The bottom surfaces 91a of the slits 91 are slightly shallower than the bottom surfaces 83a of the grooves 83, that is, the bottom surfaces 91a of the slits 91 are located slightly below the bottom surfaces 83a of the grooves 83.

Between the bottom surface 91a of each of the slits 91 and the top T2 of the curved surface of a corresponding one of the supporting disks 90, a space 92 corresponding to the permissible amount of wear of the ejection driving rollers 44 is initially formed. When the ejection driving rollers 44 are worn away by the permissible amount of wear, the spaces 92 disappear, and the tops T2 of the curved surfaces of the supporting disks 90 come into contact with the bottom surfaces 91a of the slits 91 and support the lower surface 55b of the holding tray 55. When a recording material transport device 5A having such a configuration is used, the same effect as the embodiment shown in FIGS. 3 to 9 can be obtained.

### Embodiment 3

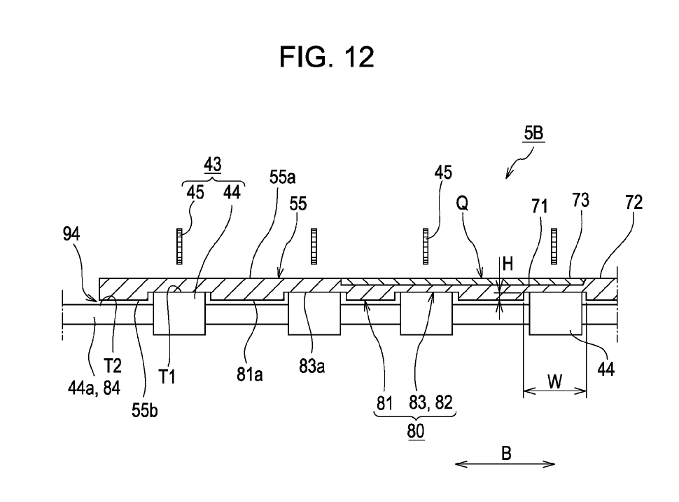

FIG. 12 is a vertical sectional view showing still another embodiment in which the posture maintainer has a different configuration taken along the nip of the ejection roller. As shown in FIG. 12, between the roller driving shaft 44a of the ejection driving rollers 44 and each of the top surfaces 81a of the projections 81 on the lower surface 55b of the holding tray 55, a space 94 similar to the spaces 92 of the embodiment shown in FIGS. 10, 11A, and 11B is initially formed. When the recording material transport device 5B of the embodiment shown in FIG. 12 is used, the same effect as the embodiment shown in FIGS. 10, 11A, and 11B can be obtained.

### Other Embodiments

The top T2 of the posture maintainer 84 can be initially set to the same height as the lower surface 55b of the holding tray 55. For example, in the case of the embodiment shown in FIGS. 3 to 9, the upper surfaces 87L and 87R of the supporting ridges 85L and 85R, respectively, can be set to the same height as the top T2 of the curved surface of the transport driving roller 35. In the case of the embodiment shown in FIGS. 10, 11A, and 11B, instead of providing the spaces 92, the tops T2 of the curved surfaces of the supporting disks 90 can be initially in contact with the bottom surfaces 91a of the slits 91. In the case of the embodiment shown in FIG. 12, instead of providing the spaces 94, the top T2 of the curved surface of the roller driving shaft 44a of the ejection driving roller 44 can be initially in contact with the top surfaces 81a of the projections 81 on the lower surface 55b of the holding tray 55.

What is claimed is:

1. A recording apparatus comprising:
a recording executing section that can execute recording on both a first recording material and a second recording material set on a first surface of a holding tray in a recording execution area;
a transport driving roller that applies feeding force toward the recording execution area to a second surface of the holding tray; and
an ejection driving roller that is located downstream of the transport driving roller and applies feeding force that feeds the first recording material from the same side as the transport driving roller in the ejecting direction, to the first recording material,
wherein the transport of the holding tray in the recording execution area is performed by the feeding force of the transport driving roller and the ejection driving roller, and the maintenance of the posture of the holding tray in the recording execution area is performed by the transport driving roller, the ejection driving roller, and a posture maintainer located outside a transit area through which the first recording material passes.

2. The recording apparatus according to claim 1,
wherein the curved surface of the transport driving roller and the curved surface of the ejection driving roller are initially in contact with the second surface of the holding tray, the posture of the holding tray is maintained in the contact state,
the top of the posture maintainer is initially set at a position distant from the second surface of the holding tray, the variation with time of the posture of the holding tray brings the top of the posture maintainer into contact with the second surface of the holding tray, and the posture of the holding tray is thereby maintained.

3. The recording apparatus according to claim 1, wherein the posture maintainer is provided downstream of the transport driving roller.

4. The recording apparatus according to claim 1, wherein the posture maintainer is provided on a part of the roller driving shaft of the ejection driving roller near the ejection driving roller.

5. A recording apparatus comprising:
a transport driving roller that supports both a first recording material and a second recording material set on a holding tray while applying transporting force thereto;
a recording executing section that faces the first and second recording materials being transported;
an ejection driving roller that is located downstream of the transport driving roller and supports the first recording material and the holding tray while applying transporting force thereto, and
a posture maintainer that supports the holding tray together with the transport driving roller and thereby defines the supported posture of the holding tray relative to the recording executing section and that is located downstream of the transport driving roller and supports the holding tray substantially without applying driving force thereto,
wherein the posture maintainer is provided outside a transit area corresponding to the standardized size of the first recording material.
